(19) United States
(12) Patent Application Publication
(10) Pub. No.: US 2007/0148555 A1
(43) Pub. Date: Jun. 28, 2007

(54) Nonaqueous electrolyte composition and nonaqueous electrolyte secondary battery using the same

(75) Inventors: Atsushi Fukaya, Aichi (JP); Kyohei Usami, Aichi (JP); Naomi Awano, Aichi (JP); HIroyuki Tachikawa, Tokyo (JP); Takayuki Taki, Tokyo (JP)

Correspondence Address: YOUNG & THOMPSON, 745 SOUTH 23RD STREET, 2ND FLOOR, ARLINGTON, VA, 22202, US

(73) Assignee: ADEKA CORPORATION, TOKYO (JP)

(21) Appl. No.: 10/594,405

(22) PCT Filed: Apr. 28, 2005
(86) PCT No.: PCT/JP05/08146

§ 371 Date: Sep. 26, 2006

(30) Foreign Application Priority Data
May 11, 2004 (JP) 2004-140889

(51) Int. Cl. H01M 10/40

(52) U.S. Cl. 429/331; 429/332

(57) ABSTRACT

Disclosed is a nonaqueous electrolyte composition obtained by dissolving an electrolyte salt in an organic solvent. This nonaqueous electrolyte composition is characterized in that the organic solvent is a mixed organic solvent containing 20-35 volume % of ethylene carbonate (a), 35-45 volume % of ethyl methyl carbonate (b), 15-35 volume % of dimethyl carbonate (c) and 3-15 volume % of diethyl carbonate or propylene carbonate (d). With this nonaqueous electrolyte composition, there can be obtained a nonaqueous electrolyte secondary battery having excellent low-temperature characteristics as well as excellent storage characteristics or cycle characteristics.

### TECHNICAL FIELD

This invention relates to a nonaqueous electrolyte composition and a nonaqueous electrolyte secondary battery using the composition. More particularly, it relates to a nonaqueous electrolyte composition having an electrolyte salt dissolved in an organic solvent, the organic solvent being a mixed organic solvent containing (a) 20% to 35% by volume of ethylene carbonate, (b) 35% to 45% by volume of ethyl methyl carbonate, (c) 15% to 35% by volume of dimethyl carbonate, and (d) 3% to 15% by volume of diethyl carbonate or propylene carbonate. The invention also relates to a nonaqueous electrolyte secondary battery which contains the nonaqueous electrolyte composition and exhibits excellent room-temperature and low-temperature battery characteristics after cycles.

### BACKGROUND ART

In recent years, nonaqueous electrolyte secondary batteries using metallic lithium, a lithium alloy or a substance capable of intercalating and deintercalating lithium ions as a negative electrode active material have been attracting attention for their advantages including higher energy density and lower self discharge. The disadvantage of the nonaqueous secondary batteries of this type is that, because a high voltage is achieved, the electrolyte is apt to decompose in both positive and negative electrodes, which causes poor storage stability and difficulty in securing a long cycle life.

It has therefore been one of the most important problems in developing practical nonaqueous electrolyte secondary batteries to develop a nonaqueous electrolyte having excellent storage or cycle characteristics. A nonaqueous electrolyte is a solution of an electrolyte as a solute in an organic solvent. Requirements for the organic solvent include (1) having a large dielectric constant, (2) being capable of dissolving a large quantity of an electrolyte solute, (3) having a low viscosity, (4) having excellent low-temperature characteristics, (5) being stable against oxidation and reduction and not decomposing due to oxidation and reduction, and (6) having low volatility to secure safety in use.

Historically, low boiling solvents, such as 1,2-dimethoxyethane and 1,3-dioxolane, have been used in nonaqueous electrolyte secondary batteries. However, these low boiling solvents not only have a small dielectric constant but, when used alone, are reactive with lithium of the negative electrode material. As a result of the reaction with the solvent, lithium is leached into the electrolyte solution, which results in reduction of storage characteristics. Furthermore, because a lithium oxide film resulting from the reaction has poor ion conductivity, the internal resistance of the battery increases, and the high rate discharge characteristics are deteriorated.

For application to nonaqueous electrolyte secondary batteries, therefore, a mixed solvent comprising a cyclic carbonic ester having a high dielectric constant, such as ethylene carbonate or propylene carbonate, and a low boiling solvent, such as 1,2-dimethoxyethane or tetrahydrofuran is used. Using this type of a solvent system is a strategy such that the cyclic carbonic ester reacts with lithium to form a lithium carbonate film with high ion conductivity on the negative electrode surface and that the low boiling solvent serves to reduce the viscosity of the electrolyte, whereby to prevent reduction of ion conductivity of the electrolyte and to improve high rate discharge characteristics.

Having low oxidation-reduction potential, however, the low boiling solvent such as 1,2-dimethoxyethane or tetrahydrofuran is susceptible to decomposition on the contact interface with a high-potential positive electrode. Moreover, when stored in a high temperature for a long time, the low boiling solvent gradually decomposes the lithium carbonate film formed on the negative electrode surface into an insulating lithium oxide film. Thus, the presence of the low boiling solvent improves the high rate discharge characteristics in the initial stage to some extent but fails to secure satisfactory high rate discharge characteristics after storage.

Therefore, improvements concerning a solvent for nonaqueous electrolytes have been keenly demanded. Along this line, Patent Document 1, Patent Document 2, Patent Document 3, Patent Document 4, Patent Document 5, and Patent Document 6 propose using a mixed solvent comprising a cyclic carbonate compound, e.g., ethylene carbonate, propylene carbonate, 1,2-butylene carbonate or vinylene carbonate, and an acyclic carbonate compound, e.g., dimethyl carbonate, diethyl carbonate or dipropyl carbonate.

Patent Document 7 discloses an electrolyte composition prepared by forcibly subjecting a mixture of dimethyl carbonate and diethyl carbonate to interesterification in the presence of a catalyst to form a mixture containing three carbonates: dimethyl carbonate, diethyl carbonate, and ethyl methyl carbonate in equilibrium and then adding ethylene carbonate to the mixture.

Patent Document 1: JP 6-84542A

Patent Document 2: JP 2003-323915A

Patent Document 3: JP 3157209B

Patent Document 4: JP 3311104B,

Patent Document 5: JP 3428750B

Patent Document 6: JP 2000-67914A

Patent Document 7: JP 2002-117898A

Replacement of 1,2-dimethoxyethane, tetrahydrofuran, etc. with the acyclic carbonate compound brings about some improvement on high rate discharge characteristics in the initial stage and after storage but still fails to provide an electrolyte with sufficient low temperature characteristics.

### DISCLOSURE OF THE INVENTION

As described, the problem to be solved is that there has not been an electrolyte that exhibits satisfactory low-temperature characteristics.

An object of the present invention is to provide a nonaqueous electrolyte secondary battery excellent in storage characteristics or cyclic characteristics by using an electrolyte composition with superior low-temperature characteristics.

As a result of extensive investigations in the light of the above-mentioned circumstances, the present inventors have found that a nonaqueous electrolyte composition that sustains satisfactory low temperature characteristics even after cycles can be obtained by using specific carbonate compounds in a specific ratio.

The present invention has been completed based on the above findings. The invention provides a nonaqueous electrolyte composition having an electrolyte salt dissolved in an organic solvent. The organic solvent is a mixed organic solvent containing (a) 20% to 35% by volume of ethylene carbonate, (b) 35% to 45% by volume of ethyl methyl carbonate, (c) 15% to 35% by volume of dimethyl carbonate, and (d) 3% to 15% by volume of diethyl carbonate or propylene carbonate.

The invention also provides a nonaqueous electrolyte secondary battery having a nonaqueous electrolyte, a positive electrode, and a negative electrode. The nonaqueous electrolyte secondary battery of the invention is characterized by using the nonaqueous electrolyte composition of the invention.

### BRIEF DESCRIPTION OF THE DRAWINGS

FIG. 1 is a perspective cross-sectional view illustrating the inner structure of a cylindrical lithium secondary battery as a nonaqueous electrolyte secondary battery of the present invention.

FIG. 2 schematically illustrates the basic structure of a lithium secondary battery as a nonaqueous electrolyte secondary battery of the present invention.

### BEST MODE FOR CARRYING OUT THE INVENTION

The nonaqueous electrolyte composition of the invention and the nonaqueous electrolyte secondary battery of the invention using the nonaqueous electrolyte composition will be described in detail with reference to their preferred embodiments.

The nonaqueous electrolyte composition according to the invention is a composition having an electrolyte salt dissolved in an organic solvent, characterized in that the organic solvent is a mixed organic solvent containing (a) 20% to 35% by volume of ethylene carbonate, (b) 35% to 45% by volume of ethyl methyl carbonate, (c) 15% to 35% by volume of dimethyl carbonate, and (d) 3% to 15% by volume of diethyl carbonate or propylene carbonate. The nonaqueous electrolyte composition of the invention may consist solely of components (a) to (d) or, if desired, may further contain other cyclic carbonate compounds, other acyclic carbonate compounds, or other organic solvents.

To sufficiently secure low temperature performance, the organic solvent used in the nonaqueous electrolyte composition of the invention preferably contains (a) 25% to 35% by volume of ethylene carbonate, (b) 35% to 45% by volume of ethyl methyl carbonate, (c) 18% to 32% by volume of dimethyl carbonate, and (d) 3% to 10% by volume of diethyl carbonate or propylene carbonate.

More specifically, a first example of the organic solvent system preferred to sufficiently secure low temperature performance is (a) 30% by volume of ethylene carbonate, (b) 40% by volume of ethyl methyl carbonate, (c) 20% by volume of dimethyl carbonate, and (d) 10% by volume of diethyl carbonate.

A second example the organic solvent system preferred to sufficiently secure low temperature performance is (a) 25% by volume of ethylene carbonate, (b) 40% by volume of ethyl methyl carbonate, (c) 30% by volume of dimethyl carbonate, and (d) 5% by volume of diethyl carbonate.

A third example the organic solvent system preferred to sufficiently secure low temperature performance is (a) 25% by volume of ethylene carbonate, (b) 40% by volume of ethyl methyl carbonate, (c) 25% by volume of dimethyl carbonate, and (d) 10% by volume of diethyl carbonate.

A fourth example the organic solvent system preferred to sufficiently secure low temperature performance is (a) 25% by volume of ethylene carbonate, (b) 40% by volume of ethyl methyl carbonate, (c) 30% by volume of dimethyl carbonate, and (d) 5% by volume of propylene carbonate.

The other cyclic carbonate compounds that can be used in combination in the nonaqueous electrolyte composition of the invention include vinylene carbonate, 1,2-butylene carbonate, 2-methyl-1,2-butylene carbonate, 1,1-dimethylethylene carbonate, 2-methyl-1,3-propylene carbonate, and 3-methyl-1,3-propylene carbonate. The other acyclic carbonate compounds that can be used in combination include ethyl n-butyl carbonate, methyl t-butyl carbonate, diisopropyl carbonate, and t-butyl isopropyl carbonate. Also useful are 1,2-bis(methoxycarbonyloxy)ethane, 1,2-bis(ethoxycarbonyloxy)ethane, 1,2-bis(ethoxycarbonyloxy)propane, etc., which are alkylene bis-carbonate compounds classified into acyclic carbonate compounds.

The other organic solvents that can be used in combination include cyclic ester compounds such as γ-butyrolactone and γ-valerolactone; sulfone or sulfoxide compounds such as sulfolane, sulfolene, tetramethylsulfolane, diphenyl sulfone, dimethyl sulfone, and dimetbyl sulfoxide; and amide compounds such as N-methylpyrrolidone, dimethylformamide, and dimethylacetamide.

Also included in the other organic solvents are acyclic or cyclic ether compounds that have a low viscosity and are capable of improving the low temperature performance of an electrolyte. Such acyclic or cyclic ether compounds include tetrahydrofuran, dioxolane, and dioxane. The other organic solvents further include acyclic ester compounds, such as methyl formate, ethyl formate, methyl acetate, ethyl acetate, propyl acetate, sec-butyl acetate, butyl acetate, methyl propionate, and ethyl propionate. Acetonitrile, propionitrile, nitromethane and their derivatives are also useful.

The other useful organic solvents additionally include glycol diether compounds classified into acyclic ethers. Examples of the glycol diether compounds are ethylene glycol bis(trifluoroethyl)ether, isopropylene glycol trifluoroethyl ether, ethylene glycol bis(trifluoromethyl)ether, and diethylene glycol bis(trifluoroethyl)ether. Having fluorine-substituted end groups, these compounds act like a surface active agent in the electrode interface to increase the affinity of the nonaqueous electrolyte composition to the electrode. This leads to reduction of initial stage internal resistance of the battery and improvement of lithium ion mobility.

To secure a high dielectric constant and satisfactory low temperature performance of the electrolyte, it is preferred that the proportion of the total amount of components (a) to (d) in the organic solvent system be in the range of 70% to 100% by volume, still preferably 90% to 100% by volume, with the proportion of the organic solvents other than components (a) to (d), if any, ranging 0% to 30% by volume.

The nonaqueous electrolyte composition can further contain at least one member selected from a silicon compound represented by general formula (1) and a silicon compound represented by general formula (2) to exhibit further improved cycle characteristics. 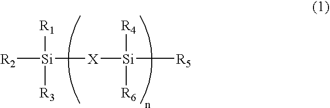
wherein R₁, R₂, R₃, R₄, R₅, and R₆ each represent an alkyl group, an alkoxy group, an alkenyl group, an alkenyloxy group, an alkynyl group, an alkynyloxy group, an aryl group or an aryloxy group, each of which may have an ether bond in its chain; n represents 0 to 5; when n is 1 to 5, X represents a single bond, an oxygen atom, an alkylene group, an alkylenedioxy group, an alkenylene group, an alkenylenedioxy group, an alkynylene group, an alkynylenedioxy group, an arylene group or an arylenedioxy group; provided that at least one of R₁ to R₆, and X contains an unsaturated bond. 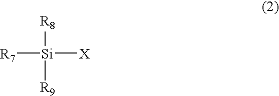
wherein R₇ represents an alkenyl group having 2 to 10 carbon atoms; R₈ and R₉ each represent an alkyl group having 1 to 10 carbon atoms, an alkoxy group having 1 to 10 carbon atoms, an alkenyl group having 2 to 10 carbon atoms or a halogen atom; and X represents a halogen atom.

In general formula (1), the alkyl group and the alkoxy group as represented by R₁, R₂, R₃, R₄, R₅, and R₆ preferably include alkyl groups having 1 to 12 carbon atoms, such as methyl, ethyl, propyl, isopropyl, butyl, sec-butyl, tert-butyl, pentyl, hexyl, heptyl, octyl, isooctyl, 2-ethylhexyl, nonyl, decyl, undecyl, and dodecyl; and alkoxy groups derived from the alkyl groups recited. The alkenyl group and the alkenyloxy group preferably include alkenyl groups having 2 to 8 carbon atoms, such as vinyl, allyl, 1-propenyl, isopropenyl, 2-butenyl, 1,3-butadienyl, 2-pentenyl, and 2-octenyl; and alkenyloxy groups derived from the alkenyl groups recited. The alkynyl group and the alkynyloxy group preferably include alkynyl groups having 2 to 8 carbon atoms, such as ethynyl, 2-propynyl, and 1,1-dimethyl-2-propynyl; and alkynyloxy groups derived from the alkynyl groups recited. The aryl group and the aryloxy group preferably include aryl groups having 6 to 12 carbon atoms, such as phenyl, tolyl, xylyl, and tert-butylphenyl; and aryloxy groups derived from these aryl groups. The alkylene group and the alkylenedioxy group as represented by X preferably include alkylene groups having 1 to 8 carbon atoms, such as methylene, ethylene, trimethylene, 2,2-dimethyltrimethylene, tetramethylene, pentamethylene, and hexamethylene; and alkylenedioxy groups derived from these alkylene groups. The alkenylene group and alkenylenedioxy group preferably include alkenylene groups having 2 to 8 carbon atoms, such as vinylene, propenylene, isopropenylene, butenylene, and pentenylene; and alkenylenedioxy groups derived therefrom. The alkynylene group and the alkynylenedioxy group preferably include alkynylene groups having 2 to 8-carbon atoms, such as ethynylene, propynylene, butynylene, pentynylene, and 1,1,4,4-tetramethylbutynylene; and alkynylenedioxy groups derived therefrom. Examples of the arylene group and the arylenedioxy group preferably include arylene groups having 6 to 12 carbon atoms, such as phenylene, methylphenylene, dimethylphenylene, and tert-butylphenylene; and arylenedioxy groups derived therefrom.

Specific examples of the silicon compounds represented by general formula (1) are shown below for illustrative purposes only but not for limitation.

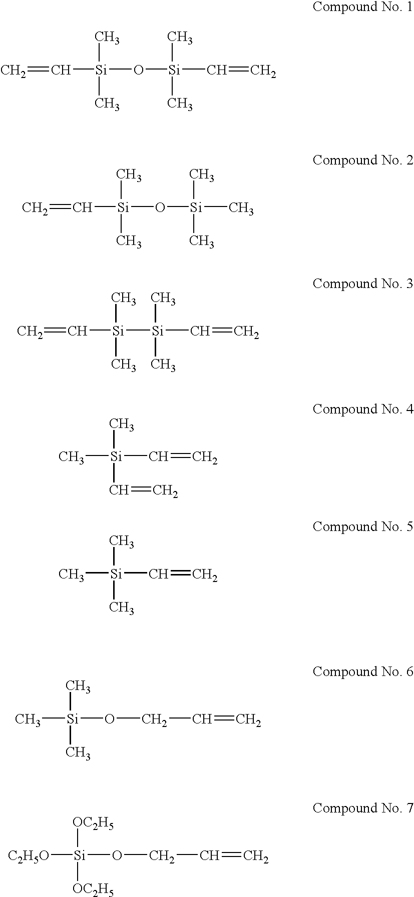

The silicon compounds having an unsaturated bond represented by general formula (1) are known compounds and are not limited by the method of synthesis; Compound No. 1, for example, can be obtained by dehydrocoupling reaction between a hydrogen-containing silicon compound and a hydroxyl-containing silicon compound.

In general formula (2), the alkenyl group as represented by R₇, R₈, and R₉ includes vinyl, allyl, 1-propenyl, isopropenyl, 2-butenyl, 1,3-butadienyl, 2-pentenyl, and 2-octenyl. The alkyl group, alkoxy group, and alkenyl group as represented by R₈ and R₉ include alkyl groups, such as methyl, ethyl, propyl, butyl, sec-butyl, tert-butyl, pentyl, hexyl, heptyl, octyl, 2-ethylhexyl, nonyl, and decyl; alkoxy groups derived from these alkyl groups, and alkenyl groups corresponding to these alkyl groups. The halogen atom as represented by X, R₈, and R₉ includes fluorine, chlorine, bromine, and iodine.

Specific examples of the silicon compounds represented by general formula (2) are shown below for illustrative purposes only but not for limitation.

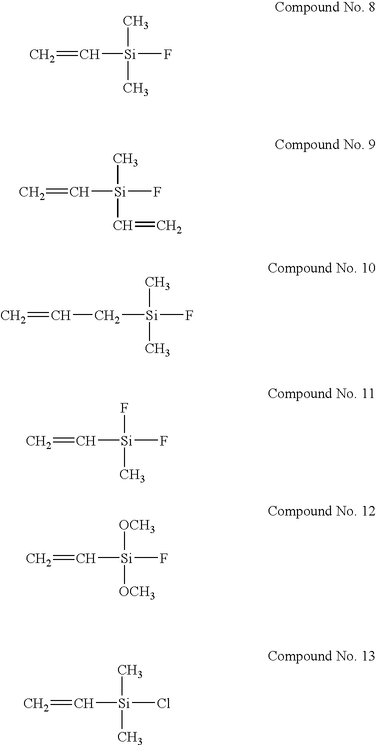

The mechanism of the action of the silicon compounds has not necessarily been elucidated. It is considered that the compound polymerizes or reacts on the electrode interface in the initial stage of cycling to form a film that retains high lithium ion conductivity even in low temperatures. A desirable amount of the silicon compound to produce the effect is 0.05 to 5 parts by mass, preferably 0.1 to 3 parts by mass, per 100 parts by mass of the total organic solvent system. At amounts less than 0.05 parts by mass, the effect of addition may be insubstantial. Addition of more than 5 parts by mass produces no further effects, which not only results in waste but rather adversely affects the characteristics of the electrolyte.

The nonaqueous electrolyte composition of the invention can contain one compound selected from the silicon compounds of general formula (1) and the silicon compounds of general formula (2) or a combination of two or more compounds selected from these silicon compounds. An organotin compound or an organogermanium compound may be added in combination.

A flame retardant of halogen, phosphorus or other types can be added to the nonaqueous electrolyte composition of the invention as appropriate to provide a flame retardant electrolyte. Phosphorus flame retardants include phosphoric esters, such as trimethyl phosphate and triethyl phosphate, melamine polyphosphate, ammonium polyphosphate, ethylenediamine polyphosphate, hexamethylenediamine polyphosphate, and piperazine polyphosphate.

The amount of the phosphorus flame retardant to be added is preferably 5 to 100 parts by mass, still preferably 10 to 50 parts by mass, per 100 parts by mass of the total organic solvent system of the nonaqueous electrolyte composition. Addition of less than 5 parts by mass of the flame retardant results in insubstantial flame retardation.

The electrolyte salt that can be used in the nonaqueous electrolyte composition of the invention is conventional. Exemplary electrolyte salts include LiPF₆, LiBF₄, LiAsF₆, LiCF₃SO₃, LiN(CF₃SO₂)₂, LiC(CF₃SO₂)₃, LiSbF₆, LiSiF₅, LiAlF₄, LiSCN, LiClO₄, LiCl, LiF, LiBr, LiI, LiAlF₄, LiAlCl₄, NaClO₄, NaBF₄, and NaI. In particular, one or a combination of two or more selected from LiPF₆, LiBF₄, LiAsF₆, and LiClO₄ (inorganic salts); LiCF₃SO₃, LiN(CF₃SO₂)₂, and LiC(CF₃SO₂)₃ (organic salts), and derivatives of these organic salts is preferred for their excellent electrical characteristics.

The electrolyte salt is preferably dissolved in the organic solvent to result in a concentration of 0.1 to 3.0 mol/l, still preferably 0.5 to 2.0 mol/l, in the nonaqueous electrolyte composition. At salt concentrations lower than 0.1 mol/l, the resulting battery can fail to have a sufficient current density. Salt concentrations higher than 3.0 mol/l can impair the stability of the electrolyte.

The nonaqueous electrolyte secondary battery according to the present invention is characterized by using the nonaqueous electrolyte composition of the invention as a nonaqueous electrolyte. The positive electrode, negative electrode, and separator that can be used in the nonaqueous electrolyte secondary battery of the invention are not particularly limited, and various materials commonly employed in nonaqueous electrolyte secondary batteries can be used as they are.

Electrode materials that can be used in the nonaqueous electrolyte secondary battery of the invention include a positive electrode and a negative electrode.

The positive electrode includes a sheet electrode prepared by applying a slurry of a positive active material, a binder, and an electroconductive material to a current collector, followed by drying. Examples of the positive active material include TiS₂, TiS₃, MoS₃, FeS₂, Li₍₁₋ₓ₎MnO₂, Li₍₁₋ₓ₎Mn₂O₄, Li₍₁₋ₓ₎CoO₂, Li₍₁₋ₓ₎NiO₂, LiV₂O₃, and V₂O₅ (wherein x is a number of 0 to 1). Preferred of these active materials are complex oxides of lithium and a transition metal, such as LiCoO₂, LiNiO₂, LiMn₂O₄, LiMnO₂, and LiV₂O₃. Binders for the positive active materials include, but are not limited to, polyvinylidene fluoride, polytetrafluoroethylene, EPDM, SBR, NBR, and fluororubber.

The electroconductive material used in the positive electrode includes, but is not limited to, fine particles of graphite and fine particles of amorphous carbon such as carbon blacks (e.g., acetylene black) and needle coke. The solvent for preparing the active material slurry is usually chosen from organic solvents capable of dissolving the binder. Examples of useful organic solvents include, but are not limited to, N-methylpyrrolidone, dimethylformamide, dimethylacetamide, methyl ethyl ketone, cyclohexanone, methyl acetate, methyl acrylate, diethyltriamine, N,N-dimethylaminopropylamine, ethylene oxide, and tetrahydrofuran. The active material mixture may be slurried in water containing a dispersant, a thickening agent, etc. with the aid of a latex, such as SBR.

The negative electrode includes a sheet electrode prepared by applying a slurry of a negative active material and a binder in a solvent to a current collector, followed by drying. The negative active material includes lithium, lithium alloys, inorganic compounds such as tin compounds, carbonaceous materials, and electroconductive polymers. Highly safe carbonaceous materials capable of intercalating and deintercalating lithium ions are preferred. Exemplary carbonaceous materials include, but are not limited to, graphite, petroleum coke, coal coke, carbonized petroleum pitch, carbonized coal pitch, carbonization products of resins such as phenol resins and crystalline cellulose resins, carbon materials obtained by partially carbonizing the above-recited materials, furnace black, acetylene black, pitch-based carbon fiber, and PAN-based carbon fiber. Examples of the binders and solvents used to form the negative electrode are the same as those enumerated for the positive electrode.

The current collector usually used in the negative electrode includes copper, nickel, stainless steel, and nickel-plated steel. The current collector usually used in the positive electrode includes aluminum, stainless steel, and nickel-plated steel.

A separator is interposed between the positive and negative electrodes in the nonaqueous electrolyte secondary battery of the invention. A commonly employed microporous polymer film can be used as a separator with no particular restriction. Polymer materials providing a microporous film separator include polyethylene, polypropylene, polyvinylidene fluoride, polyvinylidene chloride, polyacrylonitrile, polyacrylamide, polytetrafluoroethylene, polysulfone, polyether sulfone, polycarbonate, polyamide, polyimide, polyethers such as polyethylene oxide and polypropylene oxide, celluloses such as carboxymethyl cellulose and hydroxypropyl cellulose, poly(meth)acrylic acid and esters thereof; derivatives of these polymers; copolymers of monomers of the recited polymers; and polyblends of these polymer materials. The separator may be a single film or a composite film composed of two or more films. Various additives may be added to the separator film with no particular limitation on the kind and amount. A porous film made of polyethylene, polypropylene, polyvinylidene fluoride or polysulfone is particularly preferred for use in the nonaqueous electrolyte secondary battery of the invention.

The separator film is microporous for allowing the nonaqueous electrolyte to penetrate therethrough for ion conduction. Methods of forming such a microporous film includes (1) a phase separation method comprising inducing microphase separation in a solution of a polymer in a solvent while forming a film and removing the solvent by extraction and (2) a stretching method comprising extruding a molten polymer at a high draft ratio, heat treating the extruded film to unidirectionally align the crystals, and stretching the film to form voids between crystals. The method of microporous film formation is chosen according to the film material.

For the purpose of ensuring safety, a phenol antioxidant, a phosphorus antioxidant, a thioether antioxidant or a hindered amine compound can be added to the nonaqueous electrolyte composition, electrode materials, and separator.

The phenol antioxidant includes 1,6-hexamethylenebis[(3-tert-butyl-5-methyl-4-hydroxyphenyl)propionamide], 4,4′-thiobis(6-tert-butyl-m-cresol), 4,4′-butylidenebis(6-tert-butyl-m-cresol), 1,1,3-tris(2-methyl-4-hydroxy-5-tert-butylphenyl)butane, 1,3,5-tris(2,6-dimethyl-3-hydroxy-4-tert-butylbenzyl)isocyanurate, 1,3,5-tris(3,5-di-tert-butyl-4-hydroxybenzyl)isocyanurate, 1,3,5-tris(3,5-di-tert-butyl-4-hydroxybenzyl)-2,4,6-trimethylbenzene, tetrakis[methylene-3-(3,5-di-tert-butyl-4-hydroxyphenyl)propionate]methane, thiodiethylene glycol bis[(3,5-di-tert-butyl-4-hydroxyphenyl)propionate], 1,6-hexamethylenebis[(3,5-di-tert-butyl-4-hydroxyphenyl)propionate], bis[3,3-bis(4-hydroxy-3-tert-butylphenyl)butyric acid]glycol ester, bis[2-tert-butyl-4-methyl-6-(2-hydroxy-3-tert-butyl-5-methylbenzyl)phenyl]terephthalate, 1,3,5-tris[(3,5-di-tert-butyl-4-hydroxyphenyl)propionyloxyethyl]isocyanurate, 3,9-bis[1,1-dimethyl-2-{(3-tert-butyl-4-hydroxy-5-methylphenyl)propionyloxy}ethyl]-2,4,8,10-tetraoxaspiro[5,5]undecane, and triethylene glycol bis[(3-tert-butyl-4-hydroxy-5-methylphenyl)propionate].

The phosphorus antioxidant includes trisnonylphenyl phosphite, tris[2-tert-butyl-4-(3-tert-butyl-4-hydroxy-5-methylphenylthio)-5-methylphenyl]phosphite, tridecyl phosphite, octyldiphenyl phosphite, di(decyl)monophenyl phosphite, di(tridecyl)pentaerythritol diphosphite, di(nonylphenyl)pentaerythritol diphosphite, bis(2,4-di-tert-butylphenyl)pentaerythritol diphosphite, bis(2,6-di-t-butyl-4-methylphenyl)pentaerythritol diphosphite, bis(2,4,6-tri-tert-butylphenyl)pentaerythritol diphosphite, bis(2,4-dicumylphenyl)pentaerythritol diphosphite, tetra(tridecyl)isopropylidenediphenol diphosphite, tetra(tridecyl)-4,4′-n-butylidenebis(2-tert-butyl-5-methylphenol) diphosphite, hexa(tridecyl)-1,1,3-tris(2-methyl-4-hydroxy-5-tert-butylphenyl)butane triphosphite, tetrakis(2,4-di-tert-butylphenyl)biphenylene diphosphonite, 9,10-dihydro-9-oxa-10-phosphaphenanthrene 10-oxide, 2,2-methylenebis(4,6-di-tert-butylphenyl)-2-ethylhexyl phosphite, 2,2′-methylenebis(4,6-di-tert-butylphenyl)-octadecyl phosphite, 2,2′-ethylidenebis(4,6-di-tert-butylphenyl)fluorophosphite, tris(2-[(2,4,8,10-tetrakis-tert-butyldibenzo[d,f][1,3,2]dioxaphosphepin-6-yl)oxy]ethyl)amine, and 2-ethyl-2-butyl propylene glycol 2,4,6-tri-tert-butylphenol phosphite.

The thioether antioxidant includes dialkyl thiodipropionates such as dilauryl thiodipropionate, dimyristyl thiodipropionate, and distearyl thiodipropionate, and a pentaerythritol tetra(β-alkylmercaptopropionate).

The hindered amine compound includes 2,2,6,6-tetramethyl-4-piperidyl stearate, 1,2,2,6,6-pentamethyl-4-piperidyl stearate, 2,2,6,6-tetramethyl-4-piperidyl benzoate, bis(2,2,6,6-tetramethyl-4-piperidyl)sebacate, bis(1,2,2,6,6-tetramethyl-4-piperidyl) sebacate, bis(1-octyloxy-2,2,6,6-tetramethyl-4-piperidyl)sebacate, tetrakis(2,2,6,6-tetramethyl-4-piperidyl) 1,2,3,4-butanetetracarboxylate, tetrakis(1,2,2,6,6-pentamethyl-4-piperidyl) 1,2,3,4-butanetetracarboxylate, bis(2,2,6,6-tetramethyl-4-piperidyl)di(tridecyl) 1,2,3,4-butanetetracarboxylate, bis(1,2,2,6,6-pentamethyl-4-piperidyl)di(tridecyl) 1,2,3,4-butanetetracarboxylate, bis(1,2,2,4,4-pentamethyl-4-piperidyl)-2-butyl-2-(3,5-di-tert-butyl-4-hydroxybenzyl)malonate, 1-(2-hydroxyethyl)-2,2,6,6-tetramethyl-4-piperidinol/diethyl succinate polycondensate, 1,6-bis(2,2,6,6-tetramethyl-4-piperidylamino)hexane/2,4-dichloro-6-morpholino-s-triazine polycondensate, 1,6-bis(2,2,6,6-tetramethyl-4-piperidylamino)hexane/2,4-dichloro-6-tert-octylamino-s-triazine polycondensate, 1,5,8,12-tetrakis[2,4-bis(N-butyl-N-(2,2,6,6-tetramethyl-4-piperidyl)amino)-s-triazin-6-yl]-1,5,8,12-tetraazadodecane, 1,5,8,12-tetrakis[2,4-bis(N-butyl-N-(1,2,2,6,6-pentamethyl-4-piperidyl)amino)-s-triazin-6-yl]-1,5,8,12-tetraazadodecane, 1,6,11-tris[2,4-bis(N-butyl-N-(2,2,6,6-tetramethyl-4-piperidyl)amino)-s-triazin-6-yl]aminoundecane, and 1,6,11-tris[2,4-bis(N-butyl-N-(1,2,2,6,6-pentamethyl-4-piperidyl)amino)-s-triazin-6-yl]aminoundecane.

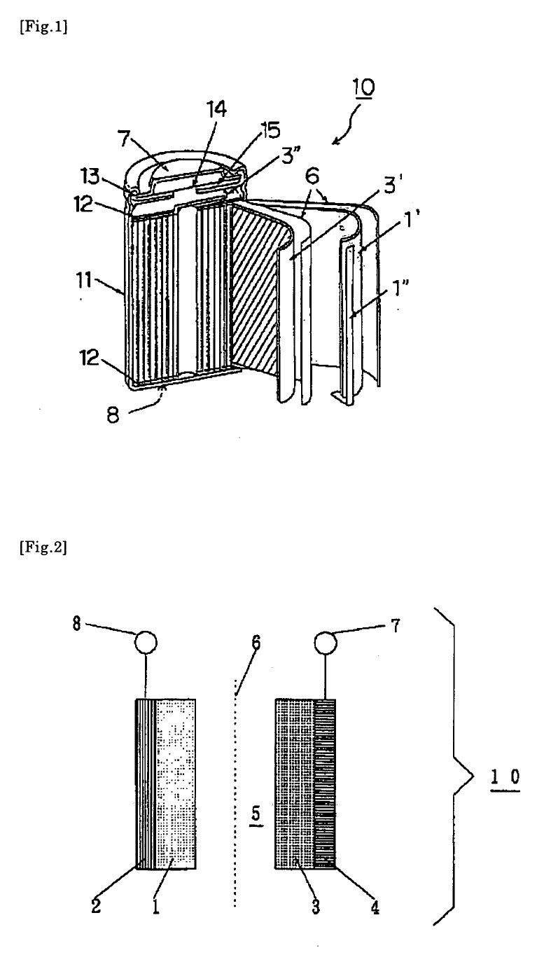

The nonaqueous electrolyte secondary battery of the invention is not particularly limited in shape and may have various shapes including a coin shape, a cylindrical shape, and a rectangular shape. The nonaqueous secondary battery according to the invention typically includes a lithium secondary battery containing lithium, a lithium alloy or a substance capable of intercalating and deintercalating lithium ions as a negative active material. The invention is also applicable to other nonaqueous electrolyte secondary batteries incorporating modifications to the lithium secondary batteries as long as the effects of the invention are not impaired. FIG. 1 illustrates the inner structure of a cylindrical battery as an embodiment of the nonaqueous electrolyte secondary battery of the invention. FIG. 2 schematically illustrates the basic structure of a nonaqueous electrolyte secondary battery using the nonaqueous electrolyte composition of the present invention.

The lithium secondary battery 10 illustrated in FIG. 2 as a nonaqueous electrolyte secondary battery is composed at least of a negative electrode 1 containing lithium, a lithium alloy or a substance capable of intercalating and deintercalating lithium ions as an active material, a negative electrode current collector 2, a positive terminal 7, and a negative terminal 8. In FIG. 2, numeral 3 indicates a positive electrode; 4, a positive electrode current collector; 5, an electrolyte; and 6, a separator. In the cylindrical battery 10 illustrated in FIG. 1, numeral 1′ indicates a negative electrode plate; 1″, a negative electrode lead; 3′, a positive electrode plate; 3″, a positive electrode lead; 6, a separator; 7, a positive terminal; 8, a negative terminal; 11, a case; 12, an insulating plate; 13, a gasket; 14, a safety valve; and 15, a PTC element. Other constituent materials that are usually used in nonaqueous electrolyte secondary batteries can additionally be employed according to necessity.

### EXAMPLES

The present invention will now be illustrated in greater detail with reference to Examples, but it should be understood that the invention is not limited thereto.

### Example 1 and Comparative Example 1

A lithium secondary battery was prepared as follows.

Preparation of Positive Electrode

An active material mixture of 85 parts by weight of LiNiO₂ as a positive active material, 10 parts by weight of acetylene black as an electroconductive material, and 5 parts by weight of polyvinylidene fluoride (PVDF) as a binder was dispersed in N-methyl-2-pyrrolidone (NMP) to prepare a slurry. The slurry was applied to both sides of an aluminum current collector, dried, and pressed to make a positive electrode plate. The resulting plate was cut to size, and the applied active material mixture was scraped off from a part where a lead tab for collecting electric current was to be welded to prepare a sheet positive electrode.

Preparation of Negative Electrode

A negative electrode material mixture of 92.5 parts by weight of a carbon material powder and 7.5 parts by weight of PVDF was dispersed in NMP to prepare a slurry. The slurry was applied to both sides of a copper current collector, dried, and pressed to obtain a negative electrode plate. The plate was cut to size, and the applied active material mixture was scraped off from a part where a lead tab for collecting electric current was to be welded to prepare a sheet negative electrode.

Preparation of Nonaqueous Electrolyte

LiPF₆ was dissolved in a mixed organic solvent whose formulation (unit: vol %) is shown in Tables 1 and 2 in a concentration of 1.5 mol/l to prepare a nonaqueous electrolyte. In Tables 1 and 2, EC stands for ethylene carbonate; EMC, ethyl methyl carbonate; DMC, dimethyl carbonate; DEC, diethyl carbonate; and PC, propylene carbonate.

Assembly of Lithium Secondary Battery

The sheet positive electrode and the sheet negative electrode were superposed on each other with a 25 μm thick microporous polyethylene film interposed between them and rolled into a spiral electrode assembly, which was put in a case. A lead one end of which was welded to the part of the positive or negative electrode where the active material mixture had been scraped off was joined to the positive or negative terminal of the case, respectively. The nonaqueous electrolyte was poured into the case having the spiral electrode assembly, and the case was closed and sealed to produce a cylindrical lithium secondary battery having a diameter of 18 mm and an axial length of 65 mm.

The lithium secondary battery was evaluated for its characteristics (initial output, output after 500 cycles, and discharge capacity retention after 500 cycles) in accordance with the following methods. The measurements were taken at 20° C. and −30° C. The results obtained are shown in Tables 1 and 2. The initial outputs were expressed relatively taking the result of Comparative Example 1-1 as 100.

Measurement of Initial Output

The battery was charged at room temperature at a constant current to an SoC (state of charge) of 60% and then discharged for 10 seconds at an operating voltage ranging from 4.1 to 3 V with a changing discharge current. A current-voltage curve at 10 second was obtained. The current at the lower limit voltage 3V was multiplied by the lower limit voltage 3V to give a value representing the output characteristics.

Measurement of Output after 500 Cycles

The lithium secondary battery was placed in a thermostat at 60° C., charged at a constant current of 2.2 mA/cm² to 4.1 V, and then discharged at a constant current of 2.2 mA/cm² to 3 V (cycled) for a total of 500 cycles. Thereafter, the value representing output characteristics of the battery was determined in the same manner as described in the measurement of initial output above.

Measurement of Discharge Capacity Retention after 500 Cycles

The battery was charged by the constant current/current voltage (CC/CV) method at 0.25 mA/cm² to 4.1 V and then discharged at a constant current of 0.33 mA/cm² to 3.0 V Then, a cycle of CC/CV charging at 1.1 mA/cm² to 4.1 V and constant current discharging at a discharge current of 1.1 MA/cm² to 3.0 V was repeated four times. Furthermore, the battery was charged at 1.1 mA/cm² to 4.1 V by the CC/CV method, followed by constant current discharge at 0.3 mA/cm² to 3.0 V. The discharge capacity at this time was taken as an initial capacity of the battery. All the above measurements were made in an atmosphere of 20° C.

The lithium secondary battery was placed in a thermostat at 60° C. and charged at a constant current of 2.2 mA/cm² to 4.1 V and discharged at a constant current of 2.2 mA/cm² to 3 V (cycled) for a total of 500 cycles. The surrounding temperature was adjusted to the measuring temperature (i.e., 20° C. or −30° C.), and the battery was charged by the CC/CV method at 1.1 mA/cm² to 4.1 V and discharged at a constant current of 0.33 mA/cm² to 3.0 V The ratio of the discharge capacity at this time to the initial capacity of the battery was taken as a discharge capacity retention after 500 cycles (%).

TABLE 1

| Example | | | | | | | |
|---|---|---|---|---|---|---|---|
| 1-1 | 1-2 | 1-3 | 1-4 | 1-5 | 1-6 | 1-7 | 1-8 |

Formulation:

| | | | | | | | | |
|---|---|---|---|---|---|---|---|---|
| EC (cyclic carbonate) | 30 | 25 | 25 | 25 | 30 | 30 | 25 | 25 |
| EMC (acyclic carbonate) | 40 | 40 | 40 | 40 | 40 | 40 | 40 | 40 |
| DMC (acyclic carbonate) | 20 | 30 | 25 | 30 | 25 | 20 | 20 | 20 |
| DEC (acyclic carbonate) | 10 | 5 | 10 | — | 5 | 5 | 15 | 10 |
| PC (5-membered cyclic carbonate) | — | — | — | 5 | — | 5 | — | 5 |

Results of Measurement:

| | | | | | | | | | |
|---|---|---|---|---|---|---|---|---|---|
| 20° C. | Initial Output | 98.9 | 99.2 | 97.9 | 99.5 | 98.5 | 98.8 | 100.0 | 98.9 |
| | Output after 500 Cycles | 88.0 | 88.0 | 86.5 | 86.7 | 87.8 | 88.1 | 88.0 | 88.1 |
| | Discharge Capacity | 80.2 | 80.3 | 79.9 | 80.5 | 80.1 | 80.1 | 80.5 | 80.0 |
| | Retention after | | | | | | | | |
| | 500 Cycles (%) | | | | | | | | |
| −30° C. | Initial Output | 113.0 | 112.8 | 114.2 | 111.0 | 115.2 | 112.7 | 112.7 | 113.2 |
| | Output after 500 Cycles | 102.0 | 102.1 | 103.5 | 105.2 | 101.9 | 101.9 | 101.8 | 101.5 |
| | Retention after | 92.5 | 92.7 | 90.7 | 91.2 | 91.0 | 91.1 | 91.5 | 91.2 |
| | 500 Cycles (%) | | | | | | | | |

TABLE 2

| Comparative Example | | | | | | |
|---|---|---|---|---|---|---|
| 1-1 | 1-2 | 1-3 | 1-4 | 1-5 | 1-6 | 1-7 |

Formulation:

| | | | | | | | |
|---|---|---|---|---|---|---|---|
| EC (cyclic carbonate) | 30 | 10 | 30 | 30 | 30 | — | 25 |
| EMC (acyclic carbonate) | 20 | 45 | 32 | 35 | — | 45 | 40 |
| DMC (acyclic carbonate) | 40 | 10 | 28 | 14 | 45 | 40 | 35 |
| DEC (acyclic carbonate) | 10 | 35 | 10 | 21 | 25 | 15 | — |
| PC (5-membered cyclic carbonate) | — | — | — | — | — | — | — |

Results of Measurement:

| | | | | | | | | |
|---|---|---|---|---|---|---|---|---|
| 20° C. | Initial Output | 100.0 | 98.2 | 98.3 | 98.1 | 98.5 | 99.1 | 99.7 |
| | Output after 500 Cycles | 79.0 | 83.4 | 77.8 | 76.2 | 75.3 | 77.2 | 75.9 |
| | Discharge Capacity | 72.9 | 77.2 | 76.7 | 74.2 | 73.2 | 73.1 | 69.9 |
| | Retention after | | | | | | | |
| | 500 Cycles (%) | | | | | | | |
| −30° C. | Initial Output | 100.0 | 103.5 | 99.1 | 98.9 | 102.5 | 100.1 | 101.3 |
| | Output after 500 Cycles | 91.9 | 92.1 | 93.3 | 92.7 | 85.0 | 85.0 | 85.2 |
| | Retention after | 88.7 | 89.1 | 88.3 | 88.6 | 86.5 | 86.0 | 87.0 |
| | 500 Cycles (%) | | | | | | | |

### Example 2 and Comparative Example 2

A lithium secondary battery was prepared in the same manner as in Example 1, except that the nonaqueous electrolyte was prepared as follows, and evaluated in the same manner as in Example 1. The results obtained are shown in Tables 3 and 4. The initial outputs were expressed relatively taking the result of Comparative Example 1-1 as 100.

Preparation of Nonaqueous Electrolyte

The additive compound shown in Tables 3 and 4 was added in the amount shown (unit: part by weight) per 100 parts by weight of a mixed organic solvent having the formulation (unit: vol %) shown in Tables 3 and 4, and LiPF₆ was dissolved therein in a concentration of 1.5 mol/l to prepare a nonaqueous electrolyte.

TABLE 3

| Example | | | | | | | |
|---|---|---|---|---|---|---|---|
| 2-1 | 2-2 | 2-3 | 2-4 | 2-5 | 2-6 | 2-7 | 2-8 |

Mixed Organic Solvent Formulation:

| | | | | | | | | |
|---|---|---|---|---|---|---|---|---|
| EC (cyclic carbonate) | 30 | 30 | 30 | 30 | 25 | 25 | 25 | 25 |
| EMC (acyclic carbonate) | 40 | 40 | 40 | 40 | 40 | 40 | 40 | 40 |
| DMC (acyclic carbonate) | 20 | 20 | 20 | 20 | 30 | 30 | 30 | 30 |
| DEC (acyclic carbonate) | 10 | 10 | 10 | 10 | 5 | 5 | 5 | 5 |
| PC (5-membered cyclic carbonate) | — | — | — | — | — | — | — | — |

Additive Compound:

| | | | | | | | | |
|---|---|---|---|---|---|---|---|---|
| Compound No. 1 | 0.4 | — | — | — | 0.4 | — | — | — |
| Compound No. 3 | — | 0.4 | — | — | — | 0.4 | — | — |
| Compound No. 10 | — | — | 0.4 | — | — | — | 0.4 | — |
| Compound No. 13 | — | — | — | 0.4 | — | — | — | 0.4 |

Results of Measurement:

| | | | | | | | | | |
|---|---|---|---|---|---|---|---|---|---|
| 20° C. | Initial Output | 100.0 | 101.0 | 100.0 | 99.9 | 100.8 | 101.2 | 100.5 | 100.2 |
| | Output after 500 Cycles | 92.1 | 93.0 | 94.8 | 94.2 | 92.0 | 93.0 | 94.8 | 94.3 |
| | Discharge Capacity | 83.9 | 85.1 | 84.3 | 84.9 | 83.8 | 84.0 | 84.7 | 85.0 |
| | Retention after | | | | | | | | |
| | 500 Cycles (%) | | | | | | | | |
| −30° C. | Initial Output | 134.3 | 134.6 | 135.2 | 134.9 | 134.1 | 134.4 | 135.0 | 134.7 |
| | Output after 500 Cycles | 120.0 | 120.5 | 124.1 | 123.0 | 120.1 | 120.6 | 124.0 | 123.2 |
| | Discharge Capacity | 96.3 | 96.1 | 97.0 | 96.9 | 97.1 | 96.5 | 96.7 | 96.0 |
| | Retention after | | | | | | | | |
| | 500 Cycles (%) | | | | | | | | |

TABLE 4

| | | | | | | | | Compara. |
|---|---|---|---|---|---|---|---|---|
| Example | | | | | | | | Example |
| 2-9 | 2-10 | 2-11 | 2-12 | 2-13 | 2-14 | 2-15 | 2-16 | 2-1 |

Mixed Organic Solvent Formulation:

| | | | | | | | | | |
|---|---|---|---|---|---|---|---|---|---|
| EC (cyclic carbonate) | 25 | 25 | 25 | 25 | 25 | 25 | 25 | 25 | 30 |
| EMC (acyclic carbonate) | 40 | 40 | 40 | 40 | 40 | 40 | 40 | 40 | 20 |
| DMC (acyclic carbonate) | 25 | 25 | 25 | 25 | 30 | 30 | 30 | 30 | 40 |
| DEC (acyclic carbonate) | 10 | 10 | 10 | 10 | — | — | — | — | 10 |
| PC (5-membered cyclic carbonate) | — | — | — | — | 5 | 5 | 5 | 5 | — |

Additive Compound:

| | | | | | | | | | |
|---|---|---|---|---|---|---|---|---|---|
| Compound No. 1 | 0.4 | — | — | — | 0.4 | — | — | — | — |
| Compound No. 3 | — | 0.4 | — | — | — | 0.4 | — | — | — |
| Compound No. 10 | — | — | 0.4 | — | — | — | 0.4 | — | — |
| Compound No. 13 | — | — | — | 0.4 | — | — | — | 0.4 | — |

Results of Measurement:

| | | | | | | | | | | |
|---|---|---|---|---|---|---|---|---|---|---|
| 20° C. | Initial Output | 99.7 | 99.9 | 99.8 | 99.6 | 100.9 | 101.5 | 100.7 | 100.5 | 100.0 |
| | Output after 500 Cycles | 90.5 | 91.8 | 93.0 | 93.7 | 90.2 | 91.6 | 93.1 | 93.0 | 76.0 |
| | Discharge Capacity | 84.6 | 85.0 | 83.8 | 84.0 | 84.9 | 85.1 | 83.9 | 84.7 | 72.9 |
| | Retention after | | | | | | | | | |
| | 500 Cycles (%) | | | | | | | | | |
| −30° C. | Initial Output | 135.0 | 135.3 | 135.8 | 134.5 | 132.1 | 133.0 | 134.6 | 133.3 | 100.0 |
| | Output after 500 Cycles | 121.5 | 122.1 | 125.4 | 123.9 | 123.0 | 123.2 | 125.6 | 124.8 | 85.0 |
| | Discharge Capacity | 96.5 | 96.3 | 96.7 | 97.0 | 96.4 | 97.1 | 96.9 | 95.9 | 87.7 |
| | Retention after | | | | | | | | | |
| | 500 Cycles (%) | | | | | | | | | |

As is apparent from the results in Tables 1 through 4, the nonaqueous electrolytes of Examples containing a specific cyclic carbonate compound and acyclic carbonate compound according to the invention were proved excellent in both room temperature and low temperature battery characteristics after cycles, particularly low temperature characteristics after cycles. In contrast, it was confirmed that use of the nonaqueous electrolytes of Comparative Examples resulted in inferior low temperature characteristics after cycles.

### INDUSTRIAL APPLICABILITY

The present invention provides a nonaqueous electrolyte secondary battery excellent in electrical characteristics at room temperature and low temperature after cycles by using a nonaqueous electrolyte composition characterized by containing specific carbonate compounds in a specific ratio.

1. A nonaqueous electrolyte composition comprising an organic solvent and an electrolyte salt dissolved in the organic solvent, the organic solvent being a mixed organic solvent comprising (a) 20% to 35% by volume of ethylene carbonate, (b) 35% to 45% by volume of ethyl methyl carbonate, (c) 15% to 35% by volume of dimethyl carbonate, and (d) 3% to 15% by volume of diethyl carbonate or propylene carbonate.

2. The nonaqueous electrolyte composition according to claim 1, wherein the organic solvent comprises (a) 25% to 35% by volume of ethylene carbonate, (b) 35% to 45% by volume of ethyl methyl carbonate, (c) 18% to 32% by volume of dimethyl carbonate, and (d) 3% to 10% by volume of diethyl carbonate or propylene carbonate.

3. The nonaqueous electrolyte composition according to claim 1, wherein the organic solvent comprises (a) 30% by volume of ethylene carbonate, (b) 40% by volume of ethyl methyl carbonate, (c) 20% by volume of dimethyl carbonate, and (d) 10% by volume of diethyl carbonate.

4. The nonaqueous electrolyte composition according to claim 1, wherein the organic solvent system comprises (a) 25% by volume of ethylene carbonate, (b) 40% by volume of ethyl methyl carbonate, (c) 30% by volume of dimethyl carbonate, and (d) 5% by volume of diethyl carbonate.

5. The nonaqueous electrolyte composition according to claim 1, wherein the organic solvent system comprises (a) 25% by volume of ethylene carbonate, (b) 40% by volume of ethyl methyl carbonate, (c) 25% by volume of dimethyl carbonate, and (d) 10% by volume of diethyl carbonate.

6. The nonaqueous electrolyte composition according to claim 1, wherein the organic solvent system comprises (a) 25% by volume of ethylene carbonate, (b) 40% by volume of ethyl methyl carbonate, (c) 30% by volume of dimethyl carbonate, and (d) 5% by volume of propylene carbonate.

7. The nonaqueous electrolyte composition according to claim 1, wherein the electrolyte salt is at least one member selected from LiPF₆, LiBF₄, LiClO₄, LiAsF₆, LiCF₃SO₃, LiN(CF₃SO₂)₂, LiC(CF₃SO₂)₃, a derivatives of LiCF₃SO₃, a derivative of LiN(CF₃SO₂)₂, and a derivative of LiC(CF₃SO₂)₃.

8. The nonaqueous electrolyte composition according to claim 1, wherein the electrolyte salt is at least one member selected from LiPF₆, LiBF₄, LiClO₄, LiAsF₆, LiCF₃SO₃, LiN(CF₃SO₂)₂, LiC(CF₃SO₂)₃, a derivatives of LiCF₃SO₃, a derivative of LiN(CF₃SO₂)₂, and a derivative of LiC(CF₃SO₂)₃.

9. The nonaqueous electrolyte composition according to claim 1, wherein the electrolyte salt is at least one member selected from LiPF₆, LiBF₄, LiClO₄, LiAsF₆, LiCF₃SO₃, LiN(CF₃SO₂)₂, LiC(CF₃SO₂)₃, a derivatives of LiCF₃SO₃, a derivative of LiN(CF₃SO₂)₂, and a derivative of LiC(CF₃SO₂)₃.

10. The nonaqueous electrolyte composition according to claim 1, wherein the electrolyte salt is at least one member selected from LiPF₆, LiBF₄, LiClO₄, LiAsF₆, LiCF₃SO₃, LiN(CF₃SO₂)₂, LiC(CF₃SO₂)₃, a derivatives of LiCF₃SO₃, a derivative of LiN(CF₃SO₂)₂, and a derivative of LiC(CF₃SO₂)₃.

11. The nonaqueous electrolyte composition according to claim 1, further comprising at least one member selected from a silicon compound represented by general formula (1) and a silicon compound represented by general formula (2): 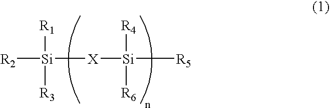
wherein R₁, R₂, R₃, R₄, R₅, and R₆ each represent an alkyl group, an alkoxy group, an alkenyl group, an alkenyloxy group, an alkynyl group, an alkynyloxy group, an aryl group or an aryloxy group, each of which may have an ether bond in its chain; n represents 0 to 5; when n is 1 to 5, X represents a single bond, an oxygen atom, an alkylene group, an alkylenedioxy group, an alkenylene group, an alkenylenedioxy group, an alkynylene group, an alkynylenedioxy group, an arylene group or an arylenedioxy group; provided that at least one of R₁ to R₆, and X has an unsaturated bond. 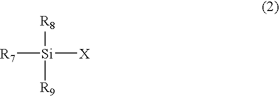
wherein R₇ represents an alkenyl group having 2 to 10 carbon atoms; R₈ and R₉ each represent an alkyl group having 1 to 10 carbon atoms, an alkoxy group having 1 to 10 carbon atoms, an alkenyl group having 2 to 10 carbon atoms or a halogen atom; and X represents a halogen atom.

12. The nonaqueous electrolyte composition according to claim 1, further comprising at least one member selected from a silicon compound represented by the general formula (1) and a silicon compound represented by the general formula (2).

13. The nonaqueous electrolyte composition according to claim 1, further comprising at least one member selected from a silicon compound represented by the general formula (1) and a silicon compound represented by the general formula (2).

14. The nonaqueous electrolyte composition according to claim 1, further comprising at least one member selected from a silicon compound represented by the general formula (1) and a silicon compound represented by the general formula (2).

15. A nonaqueous electrolyte secondary battery comprising a nonaqueous electrolyte, a positive electrode, and a negative electrode, the nonaqueous electrolyte being the nonaqueous electrolyte composition according to claim 1.

16. A nonaqueous electrolyte secondary battery comprising a nonaqueous electrolyte, a positive electrode, and a negative electrode, the nonaqueous electrolyte being the nonaqueous electrolyte composition according to claim 1.

17. A nonaqueous electrolyte secondary battery comprising a nonaqueous electrolyte, a positive electrode, and a negative electrode, the nonaqueous electrolyte being the nonaqueous electrolyte composition according to claim 1.

18. A nonaqueous electrolyte secondary battery comprising a nonaqueous electrolyte, a positive electrode, and a negative electrode, the nonaqueous electrolyte being the nonaqueous electrolyte composition according to claim 1.

19. The nonaqueous electrolyte composition according to claim 2, wherein the organic solvent comprises (a) 30% by volume of ethylene carbonate, (b) 40% by volume of ethyl methyl carbonate, (c) 20% by volume of dimethyl carbonate, and (d) 10% by volume of diethyl carbonate.

20. The nonaqueous electrolyte composition according to claim 2, wherein the organic solvent system comprises (a) 25% by volume of ethylene carbonate, (b) 40% by volume of ethyl methyl carbonate, (c) 30% by volume of dimethyl carbonate, and (d) 5% by volume of diethyl carbonate.
